(19) United States
(12) Patent Application Publication
(10) Pub. No.: US 2014/0354626 A1
(43) Pub. Date: Dec. 4, 2014

(54) Block Based Level of Detail Representation

(71) Applicants: Igor Guskov, Ann Arbor, MI (US); Paul S. Strauss, Sunnyvale, CA (US); Emil Praun, Union City, CA (US); Costa Touma, Haifa (IL)

(72) Inventors: Igor Guskov, Ann Arbor, MI (US); Paul S. Strauss, Sunnyvale, CA (US); Emil Praun, Union City, CA (US); Costa Touma, Haifa (IL)

(73) Assignee: Google Inc., Mountain View, CA (US)

(21) Appl. No.: 12/778,801

(22) Filed: May 12, 2010

(51) Int. Cl. G06T 15/00

(52) U.S. Cl. 345/419

(57) ABSTRACT

Systems and methods for block based level of detail representation are described herein. A method embodiment includes extracting one or more 3D models from 3D data, grouping the 3D models based on one or more attributes of the 3D models, distributing the grouped 3D models to a plurality of resolution levels of a geospatial data structure, and merging the grouped 3D models as a combined 3D model. A system embodiment includes a prepossessing system configured to extract one or more 3D models from 3D data and a block level of detail (LOD) creator configured to group the 3D models based on one or more attributes of the 3D models, and to render the grouped 3D models as a combined 3D model.

### BACKGROUND

1. Field

This description relates to computer graphics technology.

2. Background Art

Dense urban areas present a challenge for three dimensional (3D) level-of-detail representations that consider each 3D model (e.g. 3D building model) individually. For instance, if a coarse representation is maintained for each 3D model in a scene, then during rendering, a texture resolution would need to be individually determined for each 3D model. Determining a texture resolution for a plurality of 3D models in real-time rendering applications can be a resource intensive and time consuming operation. Although 3D models may be simplified to increase efficiency of such rendering, conventional simplification techniques fail to preserve 3D model features that are important to maintain architectural fidelity of simplified 3D models.

### BRIEF SUMMARY

Embodiments of the present invention relates to block based level of detail representation. A method embodiment includes extracting one or more three dimensional (3D) models from 3D data, grouping the 3D models based on one or more attributes of the 3D models, distributing the grouped 3D models to a plurality of resolution levels of a geospatial data structure (e.g., tree), and merging the grouped 3D models as a combined 3D model. A system embodiment includes a preprocessing system configured to extract one or more 3D models from 3D data and a block level of detail (LOD) creator configured to group the 3D models based on one or more attributes of the 3D models, and to render the grouped 3D models as a combined 3D model.

Further embodiments, features, and advantages of the embodiments, as well as the structure and operation of the various embodiments are described in detail below with reference to accompanying drawings.

### BRIEF DESCRIPTION OF THE DRAWINGS

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is an architecture diagram illustrating a preprocessing system and a client, according to an embodiment of the invention.

FIG. 2A is a diagram illustrating a block level of detail (LOD) creator, according to an embodiment.

FIG. 2B is a diagram illustrating a mesh generator, according to an embodiment.

FIGS. 3A through 6B are flowcharts illustrating different operations, according to embodiments.

FIG. 7 represents a plurality of exemplary 3D models that contribute to a block LOD representation, according to an embodiment.

FIG. 8 illustrates exemplary rendered 3D models, according to an embodiment.

FIG. 9 illustrates an example computer useful for implementing components of the embodiments.

### DETAILED DESCRIPTION

Embodiments relate to block based level of detail representation. An embodiment includes extracting one or more three dimensional (3D) models from 3D data and grouping the 3D models based on one or more attributes (e.g. height) of the 3D models. The extracted 3D models are distributed to a plurality of resolution levels of a geospatial data structure (e.g., tree) to allow rendering of the grouped 3D models as a combined 3D model. In an embodiment, the grouped 3D models may be combined together into a single textured mesh. In this way, 3D models (e.g. buildings) which share common attributes, such as a common height or location, may be represented as a single combined 3D model. This can increase rendering efficiency as individual 3D models need not be rendered separately at each resolution level.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The term “frame” as used herein refers to an image which may used to compose an image stream. As an example, one or more frames may be transmitted in sequence to a user or rendered interactively. These examples are illustrative and are not intended to limit the invention.

This detailed description of the embodiments of the present invention is divided into several sections as shown by the following table of contents.

Table of Contents

1. Pre-Processing System
2. Block LOD Creator
3. Sorting Engine
4. Height Field Generator
5. Mesh Generator
6. Proxy Plane Generator
6.1 Clustering
7. Textured Mesh Simplification
8. Example Computer Embodiment

### 1. Pre-Processing System

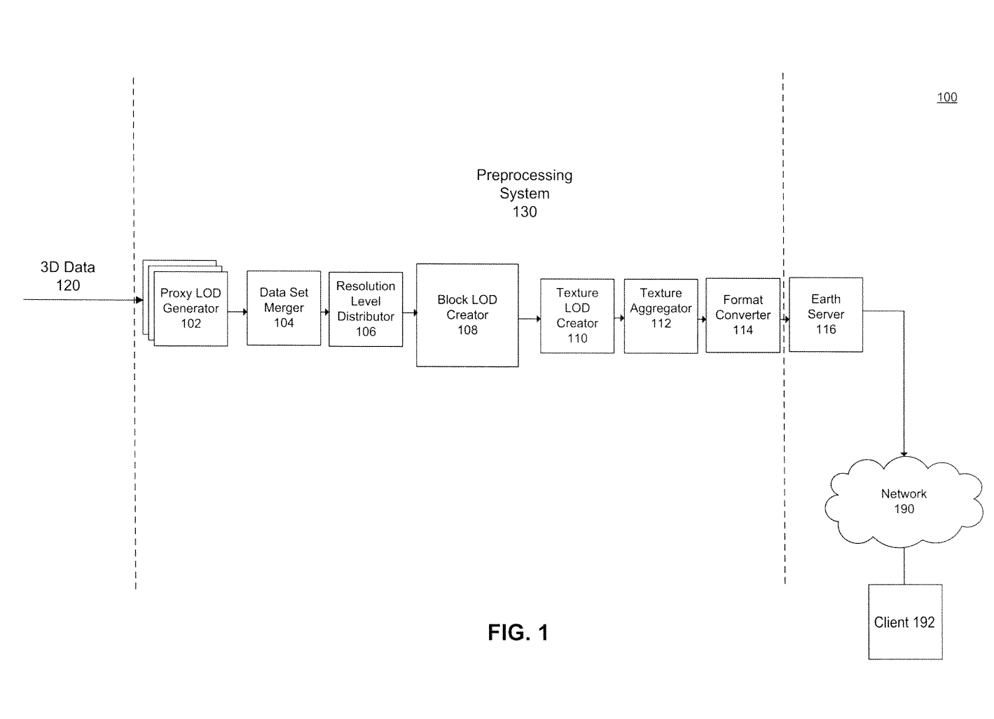

FIG. 1 shows system 100. System 100 includes a preprocessing system 130, earth server 116 and network 192. Preprocessing system 130 further includes proxy level of detail (LOD) generator 102, data set merger 104, resolution level distributor 106, block LOD creator 108, texture LOD creator 110, texture aggregator 112, and a format converter 114. Preprocessing system 130 can be coupled to earth server 116. Preprocessing system 130 can communicate with network 192 through earth server 116. In further embodiment, preprocessing system 130 can also be coupled directly to network 192 through connections not shown for clarity. In an embodiment, preprocessing system 130 constructs texture pyramids for a set of given texture images associated with 3D models and aggregates corresponding pyramid levels from multiple textures. Aggregated textures may thus form a data structure (e.g., a tree or a forest) where the textures in any given node are reduced resolutions of all the textures in the child nodes, aggregated together. As an example, the aggregated textures at a certain resolution may be stored at the nodes of a quadtree data structure. Aggregated textures are described in greater detail in U.S. patent application Ser. No. 12/419,704 (Atty. Dkt. No. 2525.1340001), entitled “Multi-Resolution Texture Aggregation,” and in U.S. patent application Ser. No. 12/421,978 (Atty. Dkt. No. 2525.1330001), entitled “Proxy Based Approach For Generation of Level of Detail,” both of which are incorporated by reference herein in its entirety.

Preprocessing system 130 may be implemented on a computing device. Preprocessing system 130 can also be implemented across a plurality of computing devices, a clustered computing environment or a server farm. Such a computing device can include, but is not limited to, a personal computer, mobile device such as a mobile phone, workstation, embedded system, game console, television, or set-top box. Such a computing device may include, but is not limited to, a device having one or more processors and memory for executing and storing instructions. Such a computing device may include software, firmware, hardware, or a combination thereof. Software may include one or more applications and an operating system. Hardware can include, but is not limited to, a processor, memory and graphical user interface display.

Network 192 can be any type of network or a combination of networks such as a local area network, wide area network or the Internet. Network 192 may be a form of a wired network or a wireless network. In an embodiment, earth server 116 may communicate over network 192.

Proxy LOD generator 102 receives three dimensional data 120. Three dimensional (3D) data 120 may include image data from various sources, including but not limited to LIDAR (Light Detection and Ranging) imagery, user contributed data, terrain data, topographic data and street and aerial imagery. In an embodiment, proxy LOD generator 102 uses 3D data 120 to generate proxy LODs. Proxy LODs are described in greater detail in U.S. patent application Ser. No. 12/419,704 (Atty. Dkt. No. 2525.1340001), entitled “Multi-Resolution Texture Aggregation,” which is incorporated by reference herein in its entirety.

Data set merger 104 merges textures associated with 3D data 120 obtained from a plurality of sources into one or more data sets.

Resolution level distributor 106 may distribute the one or more objects of interest included in the datasets obtained from data set merger 104 and their the proxy LODs generated by proxy LOD generator 102 to various resolution levels of a geo-spatial quadtree.

According to a feature, block LOD creator 108 may group the 3D models based on one or more attributes of the 3D models and to render the grouped 3D models as a combined 3D model. The operation of block LOD creator 108 is described further below.

Texture LOD generator 110 generates a resolution pyramid for each texture used by objects of interest in a scene (e.g., a building).

Texture aggregator 112 aggregates a plurality of textures at multiple resolutions, creating several texture trees, or a forest altogether.

Format converter 114 may convert the textures aggregated by texture aggregator 112 into a format used by earth server 116 to transmit the textures over network 192. According to a feature, any compressed format may be used including, but not limited to a highly compressed format. As an example, format converter 114 may convert textures to the JPEG 2000 image format. JPEG 2000 is a highly compressed image compression standard known to those skilled in the art.

Earth server 116 may transmit both textures, three dimensional geometries for 3D models combined by block LOD creator 108 over network 192. At run time, for example, earth server 116 may fulfill requests made by client 210. This example is strictly illustrative and does not limit the present invention. While earth server 116 is used in an embodiment to serve data relating to terrain on the Earth, earth server 116 may serve or provide any other form of mapping or imaging data.

In an embodiment, client 190 selects a desired resolution level for each object of interest in an image frame to be rendered and renders the object of interest for display. An exemplary client is described in detail in U.S. application Ser. No. 12/419,704 (Atty. Dkt. No. 2525.1340001), which is incorporated by reference herein in its entirety.

Although the following description is described in terms of building(s), it is to be appreciated that embodiments of the present invention may be used with any other form of structure (e.g., bridges, water dams, terrain etc.)

The following sections describe the operation of block LOD creator 108 in greater detail, according to an embodiment.

### 2. Block LOD Creator

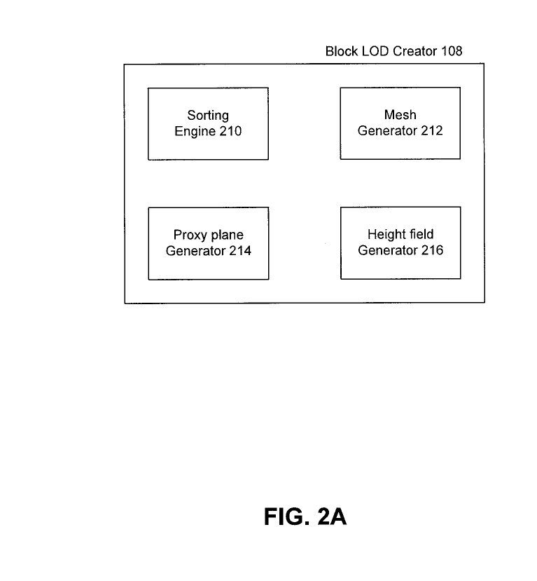

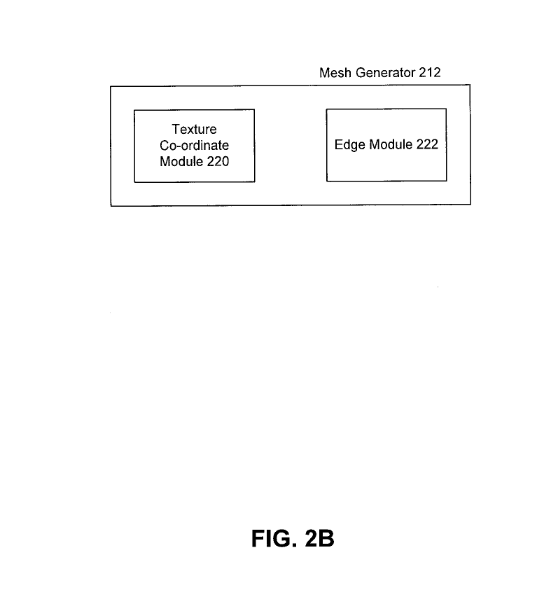

FIG. 2A illustrates an exemplary diagram of block LOD creator 108, according to an embodiment. As shown in FIG. 2A, block LOD creator 108 includes sorting engine 210, mesh generator 212, proxy plane generator 214 and height field generator 216. As shown in FIG. 2B, mesh generator 212 further includes texture coordinate module 220 and edge module 222.

### 3. Sorting Engine

In an embodiment, sorting engine 210 sorts and forms clusters of 3D models (e.g., buildings) that contribute to each block LOD created by block LOD creator 108. In a non-limiting embodiment, sorting engine 210 uses a geo-spatial quadtree decomposition of a latitude-longitude (lat-long) two-dimensional domain in order to organize such 3D model clusters. In an embodiment, sorting engine 210 organizes 3D model clusters in a manner that a grid of coarsest level image tiles covers a frame representing the Earth's surface. In an embodiment, each of the coarsest level tiles can be used as the root of a quadtree hierarchy of image tiles. In this hierarchy, each tile may be split into four non-overlapping smaller child tiles i.e., in a quadtree hierarchy. Each tile has a level associated with it, such that the level of a child tile is one plus the level of its parent tile. In an embodiment, each 3D model (e.g. building) is initially assigned to a coarsest level root tile which contains the center of its extents (or boundary) rectangle in the lat-long plane. Thus, some set of coarsest level tiles may include 3D models at the beginning of processing.

In an embodiment, the level of a tile at which a block LOD is generated can determine which block LOD models are rendered in a particular view. For better rendering performance, embodiments can render 3D models (e.g., buildings) that contribute non-trivially to a rendered image. Since a group of distant smaller 3D models may not have a visible contribution to a given frame, sorting engine 210 may place them on the finer levels of image tile hierarchy, so that they become active (for display) as client 190 zooms in closer to their location. On the other hand, taller 3D models (e.g. taller buildings) may need to appear at the coarser levels of image tile hierarchy since such taller 3D models may contribute to the skyline (e.g., a skyline of a 3D Earth representation) even when client 190 zooms out far away from their location.

In this way, sorting engine 210 generates a set of image tiles (not necessarily on the coarsest level) for which block LODs are constructed. Furthermore, according to an embodiment, for each such image tile, sorting engine 210 provides a list of building identifiers (IDs) that contribute to a block LOD of the image tile.

In a non-limiting embodiment, sorting engine 210 uses a coarse-to-fine 3D model distribution approach that starts by sorting 3D models by height within each image tile of a pre-defined coarse level of the quadtree hierarchy. Sorting engine 210 may then start a recursive assignment process that either leaves a 3D model assigned to the current tile, or passes it to one of the tile's four children (i.e., distributes the 3D model to the finer level). Although the following is discussed in terms of 3D model heights it is to be appreciated that sorting engine 210 may use any other dimension or parameter associated with a 3D model for recursive assignment.

In an embodiment, not intended to limit the invention, a decision on whether to retain a 3D model for a given image tile or pass it on to another child image tile is made, by sorting engine 210, based on several exemplary conditions.

Firstly, for example, each image tile may have a geometry limit of how much geometry information can be stored in the tile. Such a geometry limit may be specified as the total number of bytes for groups of 3D models stored within a tile. In an embodiment, 3D models whose addition would make the total number of bytes exceed such a geometry limit are passed on to the finer levels of the geospatial quadtree. In this way, because the 3D models may be assigned by sorting engine 210 in a ‘tallest assigned first’ order, such a ‘tallest assigned first’ approach assigns taller 3D models to coarser levels of the geospatial quadtree.

Secondly, in an embodiment, each image tile in the geospatial quadtree may have a minimal 3D model height (e.g. building height) for acceptance. Thus, a 3D model having a height below such a minimal height can passed on to the finer levels of the geospatial quadtree by sorting engine 210. In an embodiment, such a minimal height limit decreases at each level of the geospatial quadtree in a pre-defined fashion. Thus, each 3D model will be assigned by sorting engine 210 to a tile having an appropriate height limit value. In an embodiment, image tiles at a geospatial quadtree level may also have a maximal level. Thus, 3D models smaller than the minimal height limit can be distributed to a maximal level within the geospatial quadtree.

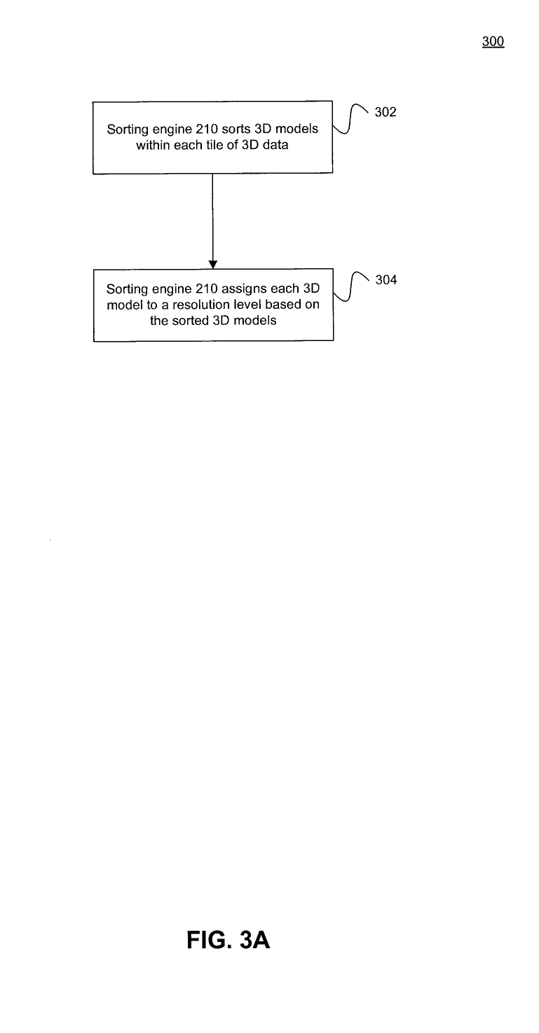

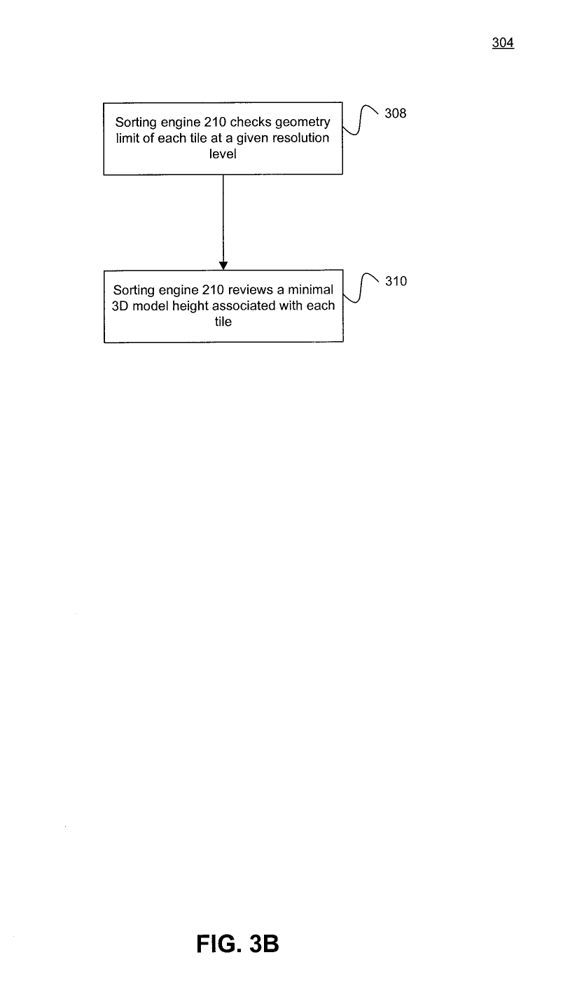

FIG. 3A is method 300 illustrating an exemplary operation of sorting engine 210, according to an embodiment. Method 300 begins with sorting engine 210 sorting 3D models within each tile of 3D data (step 302). As an example, sorting engine 210 uses a coarse-to-fine 3D model distribution approach that starts by sorting 3D models by height within each image tile of a pre-defined coarse level of the quadtree hierarchy.

Sorting engine 210 assigns each 3D model to a resolution level based on the sorted 3D models (step 304). As an example, sorting engine 210 may start a recursive assignment process that either leaves a 3D model assigned to the current tile, or passes it for processing into one of its four children (i.e., distributes the 3D model to a finer resolution level in the geospatial quadtree).

FIG. 3B is a flowchart illustrating step 304 of method 300 in greater detail. Sorting engine 210 checks a geometry limit of each tile at a given resolution level (step 308). As an example, such a geometry limit may be specified as the total number of bytes for groups of 3D models stored within a tile. Sorting engine 210 reviews a minimal 3D model height associated with each tile (step 310).

### 4. Height Field Generator

In an embodiment, height field generator 216 reviews block LOD tiles (i.e., the tiles to which 3D models have been assigned by sorting engine 210), and constructs a height field representation. In an embodiment, such a height field representation can be used by height field generator 216 to remove unnecessary topological and geometric detail (e.g., less prominent building features) in 3D models. In order to do so, and according to an embodiment, height field generator 216 combines 3D models into a single coordinate frame while accounting for their geo-location and terrain elevation. Height field generator 216 renders the 3D models into a depth buffer, thus virtually scanning a scene, and creating a height field.

In an embodiment, in order to reduce the amount of topological and geometric detail and to merge close shapes in 3D models, height field generator 216 performs a morphological opening operation. Such a morphological opening operation may be defined at each 3D model height value as the maximum of the height values in a given neighborhood followed by a minimum within the neighborhood of the same radius.

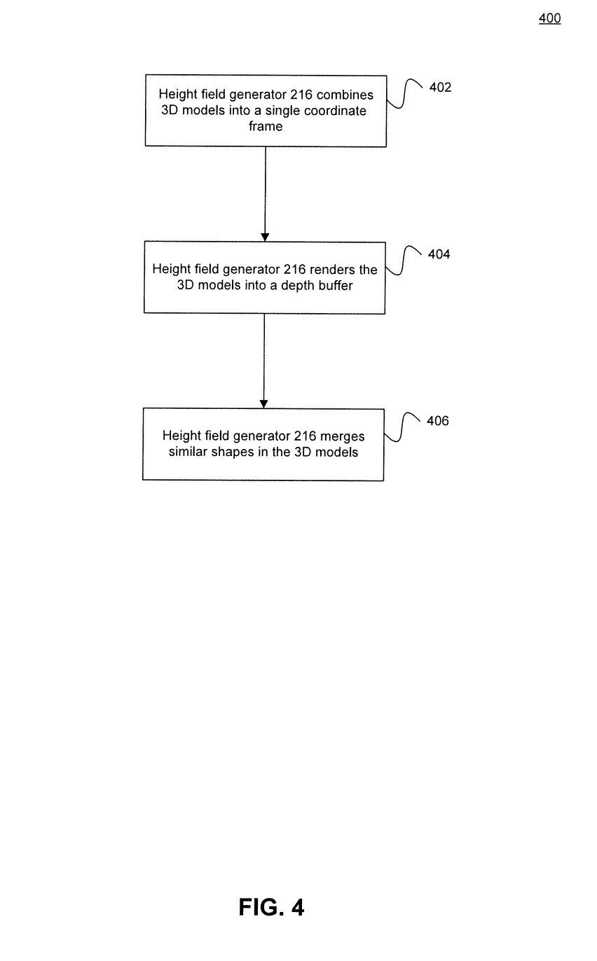

FIG. 4 is method 400 illustrating an exemplary operation of height field generator 216, according to an embodiment. Height field generator 216 combines 3D models into a single coordinate frame (step 402). As an example, height field generator 216 combines 3D models into a single coordinate frame while accounting for their geo-location and terrain elevation. Height field generator 216 renders the 3D models into a depth buffer (step 404). Height field generator 216 merges similar shapes in 3D models (step 406).

### 5. Mesh Generator

In an embodiment, mesh generator 212 interprets the height field generated by height field generator 216 as a piecewise constant function and constructs a quadrangular mesh. In an non-limiting embodiment, such a quadrangular mesh can be considered as the surface of the union of horizontal grid-aligned boxes of different heights. After the union is determined, embodiments of the invention and mesh generator 212 remove the bottom surface of the resulting shape. Thus, each quad (or face) of the quadrangular mesh can be thought of as either a wall quad or a roof quad.

Mesh generator 212 then triangulates the generated quadrangular mesh. Triangulation is well known to those skilled in the art and may be used, for example, to decompose a polygon into a set of triangles. In an embodiment, mesh generator 212 triangulates the generated quadrangular mesh while ensuring that the result is a two-manifold triangulation by splitting the vertices corresponding to some corners of polygons. In this way, mesh generator 212 generates a un-textured mesh representing the desired shape of a 3D model.

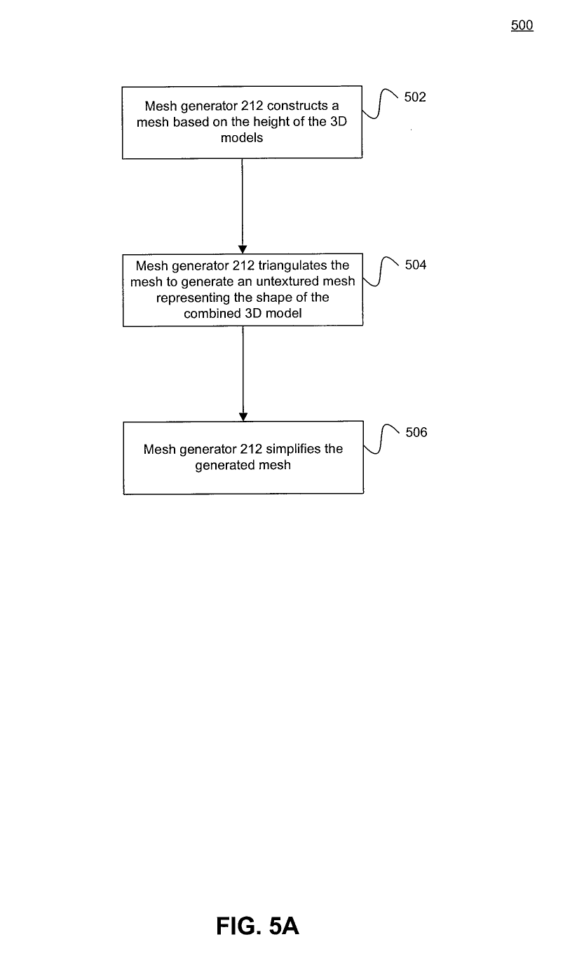

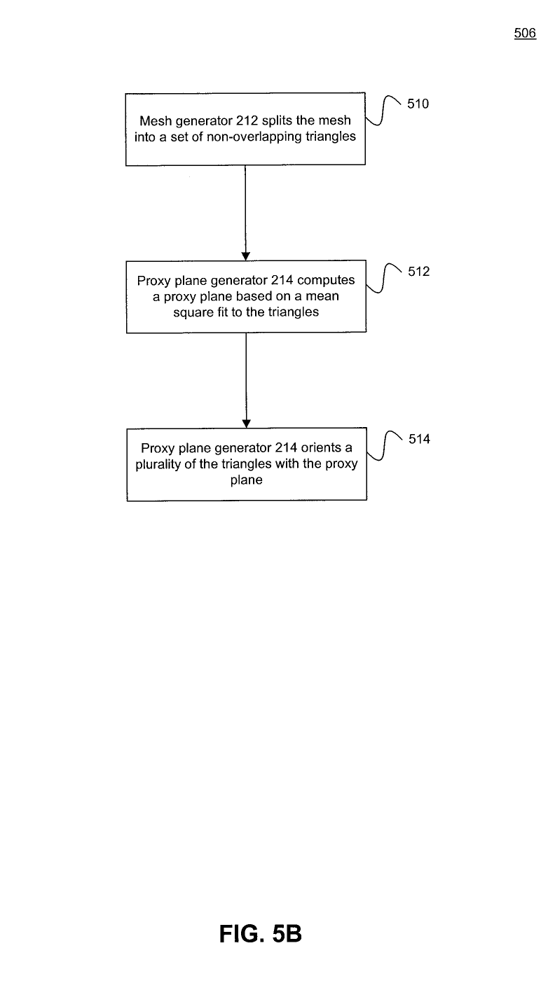

FIG. 5A is method 500 illustrating an exemplary overall operation of a mesh generator, according to an embodiment. Mesh generator 212 constructs a mesh based on the height of the 3D models (step 502). As an example, mesh generator 212 interprets the height field generated by height field generator 216 as a piecewise constant function and constructs a quadrangular mesh. Mesh generator 212 triangulates the mesh to generate an un-textured mesh representing the shape of the combined 3D model (step 504). As an example, mesh generator 212 triangulates the generated quadrangular mesh while ensuring that the result is a two-manifold triangulation by splitting the vertices corresponding to some corners of polygons. Mesh generator 212 then simplifies the generated mesh (step 506). The simplification of a quadrangular mesh generated by mesh generator 212 is described below in section 6.

### 6. Proxy Plane Generator

In an embodiment, in order to simplify the generated mesh with controlled error and prior to texturing the mesh, proxy plane generator 214 performs proxy-based shape approximation, which splits the generated mesh into a set of non-overlapping clusters of triangles. Each resulting cluster has a proxy plane such that all triangles of the cluster are no further from the plane than a given (or pre-defined) distance bound. The proxy plane is computed by proxy plane generator 214 as the best mean-square fit to the cluster triangles. In a non-limiting embodiment, such a best mean-square fit to the cluster triangles is achieved without considering the orientation of the triangles. After proxy-based shape approximation, proxy plane generator 214 orients each proxy plane consistent with the majority of the triangles in the cluster. In a non-limiting embodiment, such a cluster may be defined by the total area.

FIG. 5B is a flowchart illustrating step 506 of method 500 in greater detail. Mesh generator 212 splits the mesh into a set of non-overlapping clusters of triangles (step 510). Proxy plane generator 214 computes a proxy plane based on a mean square fit to the triangles (step 512). As an example, such best mean-square fit to the cluster triangles is achieved without considering the orientation of the triangles. Proxy plane generator 214 orients each proxy plane consistent with the majority of the triangles in the cluster (step 514).

6.1 Clustering

As discussed above, proxy plane generator 214 performs proxy-based shape approximation, which splits the mesh generated by mesh generator 212 into a set of non-overlapping clusters of triangles. In an embodiment, not intended to limit the invention, proxy plane generator 214 performs clustering by initializing a single cluster containing the largest triangle of the mesh as the seed triangle and that is associated with the corresponding proxy plane.

In an embodiment, proxy plane generator 214 then iterates through the following steps. Namely, proxy plane generator 214 associates all the triangles to the closest proxy plane. To accomplish this and according to an embodiment, a multi-seeded Dijkstra procedure is run by proxy plane generator 214. In an embodiment, such a multi-seeded Dijkstra procedure starts with a list of seed triangles, and puts their immediate neighbors (using mesh connectivity) into a border priority queue. The multi-seeded Djikstra procedure performed by proxy plane generator 214 then proceeds to select the smallest error triangle from the border list and adds the triangle to a proxy plane cluster (e.g., the best fit proxy plane cluster). The multi-seeded Djikstra procedure also adds the neighbor triangles of the selected triangle to the border priority queue. In an embodiment, the step of adding neighbor triangles of the selected triangle to the border priority queue may run until there are no more triangles within a given error distance from the current set of proxy plane clusters.

Once it is determined by proxy plane generator 214 that there are no more triangles within the given error distance from the current set of proxy plane clusters, proxy plane generator 214 updates proxy planes for each cluster by fitting them in the cluster using a mean-square fit. In an embodiment, proxy plane generator 214 updates seed triangles for each cluster by finding a triangle closest to the cluster's center of mass from the list of triangles that belong to the cluster.

If there exist any unassigned triangles, proxy plane generator 214 adds a new cluster seeded with a triangle with the highest error with respect to the current set of proxy planes.

Additionally, proxy plane generator 214 also merges clusters during iterations of the multi-seeded Djikstra procedure which created no new proxy planes. In an embodiment, proxy plane generator 214 may stop the clustering process when the number of iterations that did not create any new proxy planes reaches a predefined limit.

In this way, for example, the result of clustering performed by proxy plane generator 214 is a mesh split into a number of contiguous regions (or clusters) with an associated proxy plane. In an embodiment, each region (or cluster) may have a property that its triangles are closer than a given distance bound to the corresponding proxy plane.

In an embodiment, mesh generator 212 uses the proxy plane to create a texture for each region by initializing a virtual orthographic camera that has its viewing direction along the normal of a proxy plane and has extent defined by the projection of the cluster triangles onto the proxy plane. In an embodiment, mesh generator 212 then uses an off-screen rendering of the original scene (e.g., a combination of buildings) to create a texture image representing the scene. The texture coordinates for mesh vertices are assigned accordingly by mesh generator 212 using the projection onto the proxy plane. In this way, block LOD creator generates a textured mesh. The simplification of the resulting textured mesh by mesh generator 212 is described further below.

### 7. Textured Mesh Simplification

In an embodiment, in order to simplify the resulting textured mesh, mesh generator 212 may use a OpenMesh quadrics simplification procedure before every proposed edge collapse to simplify the textured mesh. OpenMesh is known to those skilled in the art and is a data structure for representing and manipulating polygonal meshes. In another embodiment, mesh generator 212 may check if the normals of triangles in the vicinity of a removed triangle vertex are not flipped before simplifying the textured mesh.

In an embodiment, mesh generator 212 includes a texture coordinate module 220 that checks the topological consistency of texture coordinates and the textures before and after each edge collapse performed by mesh generator 212. In this way, each cluster region of the input textured mesh is still preserved in the simplified output textured mesh and no artifacts may be created by inadvertently creating a discontinuous mapping in the texture coordinate space.

In an embodiment, mesh generator 212 also includes edge module 222 that checks if each edge collapse results in a mesh that still approximates the intermediate height field representation generated by mesh generator 212. In this way, edge module 222 prevents the creation of unwanted artifacts (e.g., fin-shaped artifacts). As an example, fin-shaped articles represent artifacts where the concave region of a model is being spanned by several coarse fin-shaped triangles in a way that some sections of the triangles depart far from the original shape of the model.

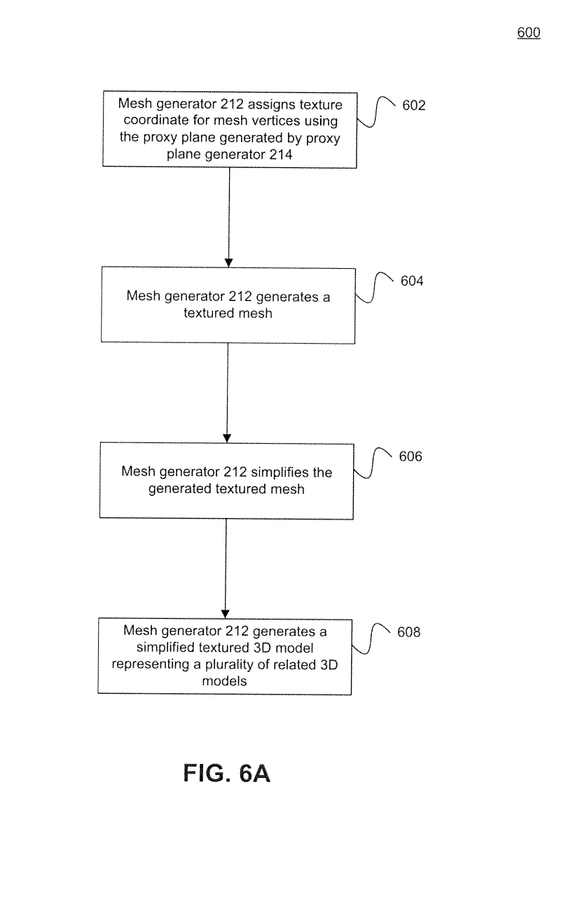

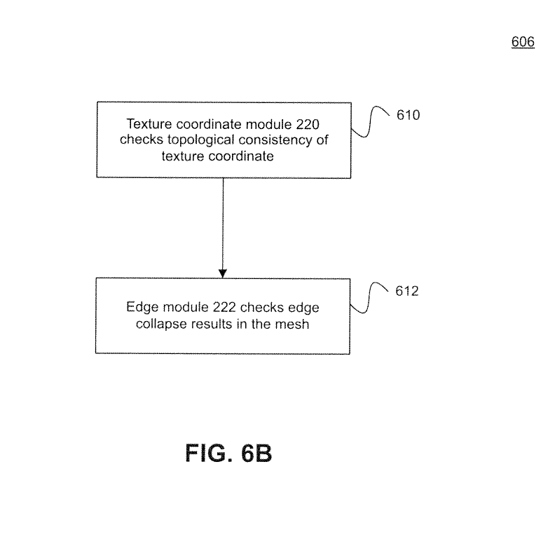

FIG. 6A is method 600 illustrating an exemplary overall operation of a mesh generator, according to an embodiment. Mesh generator 212 assigns texture coordinates for mesh vertices using the proxy plane generated by proxy plane generator 214 (step 602). As an example, the texture coordinates for mesh vertices are assigned by mesh generator 212 using the projection of the cluster triangles onto the proxy plane.

Mesh generator 212 generates a textured mesh (step 604). As an example, block LOD creator 108 then uses an off-screen rendering of the original scene (e.g., a combination of buildings) to create a texture image representing the scene.

Mesh generator 212 simplifies the generated textured mesh (step 606). As an example, in order to simplify the resulting textured mesh, mesh generator 212 may use the OpenMesh quadrics simplification procedure before every proposed edge collapse to simplify the textured mesh.

Mesh generator 212 generates a simplified textured 3D model representing a plurality of related 3D models (e.g., buildings) (step 608).

FIG. 6B is a flowchart illustrating step 606 of method 600 in greater detail. Texture coordinate module 220 checks the topological consistency of texture coordinates and the textures before and after each edge collapse performed by mesh generator 212 (step 610). Edge module 222 checks if each edge collapse results in a mesh that still approximates the intermediate height field representation generated by mesh generator 212. (step 612).

In this way, block LOD creator 108 generates a combined 3D model (e.g., a simple textured model) approximating the original collection of a plurality of 3D models. In an embodiment, block LOD creator 108 creates a new geometric object corresponding to the simplified textured mesh, and links it with original separate 3D models in a two-level (or any multi-level) LOD hierarchy.

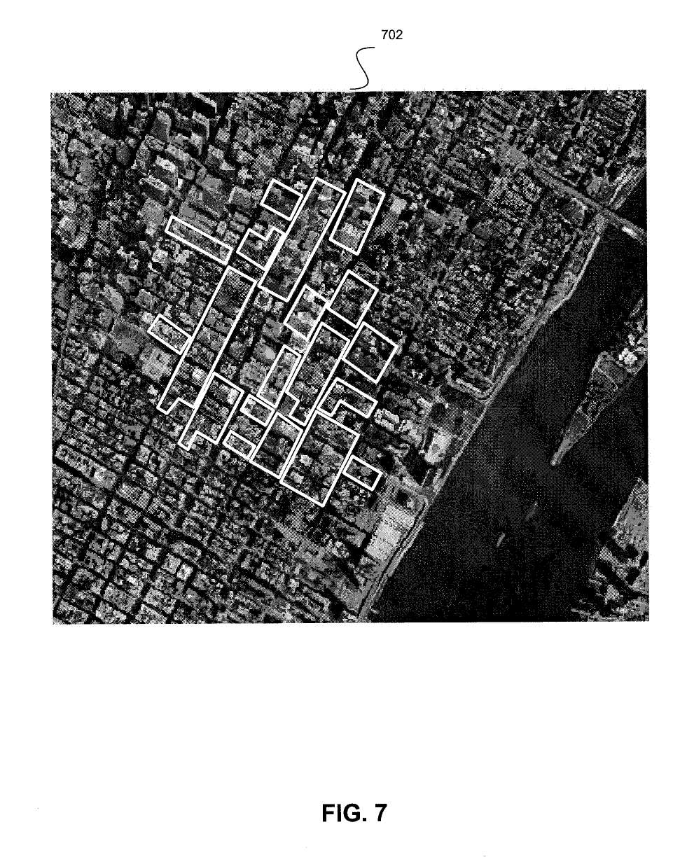

FIG. 7 represents a plurality of exemplary 3D models that contribute to a block LOD representation, according to an embodiment. As shown in FIG. 7, the regions 702, for example, represent buildings from a single tile of a geospatial quadtree whose heights fall into a range corresponding to the tile level.

If a coarse representation is maintained for each building illustrated in regions 702, then during rendering, a texture resolution would need to be individually determined for each building. Determining a texture resolution for a plurality of 3D models in real-time rendering applications can be a resource intensive and time consuming operation. Although 3D models may be simplified to increase efficiency of such rendering, conventional simplification techniques fail to preserve 3D model features that are important to maintain an architectural fidelity of simplified 3D models.

However, in an embodiment, grouped 3D buildings may be combined together into a single textured mesh. In this way, 3D models (e.g. buildings) which share common attributes, such as a common height or location, may be represented as a single combined 3D model. This can increase rendering efficiency as related 3D models need not be rendered separately at each resolution level.

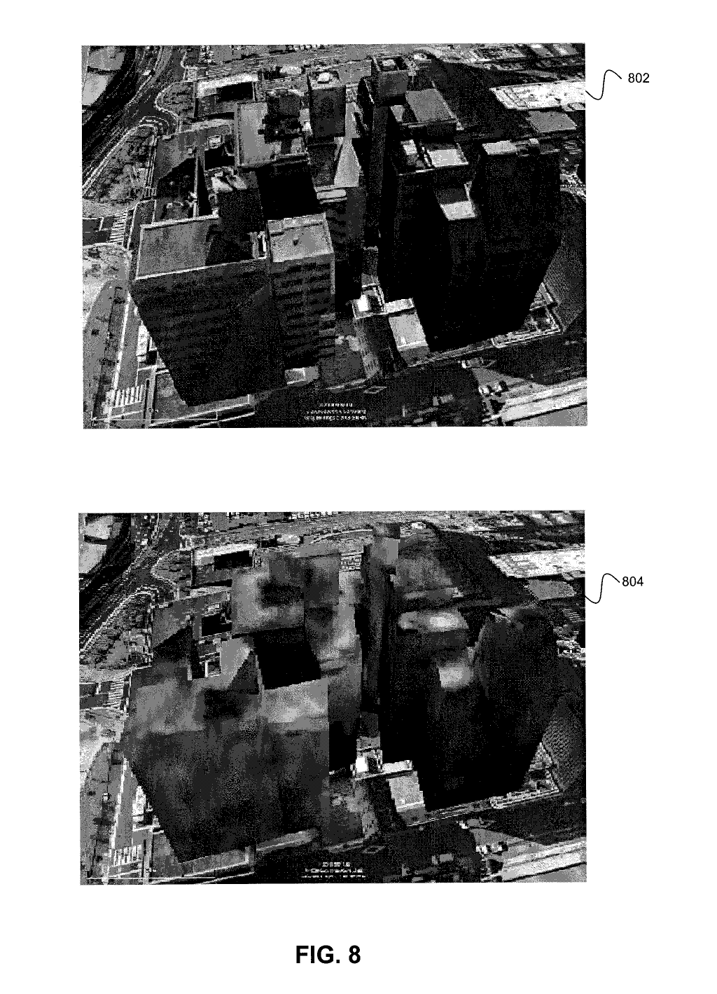

FIG. 8 illustrates exemplary urban scenes that include a plurality of buildings. As an example, such scenes may be displayed on client 190. Scene 802 represents buildings that have been rendered using conventional methods and without a block based level of detail representation. Scene 804 represents a scene where 3D building models are first combined into a single textured mesh by block LOD creator 108 and then rendered for display on client 190. As shown in scene 804, it is apparent that embodiments of the invention have preserved building features that are important to maintain an architectural fidelity of simplified building models.

### 8. Example Computer Embodiment

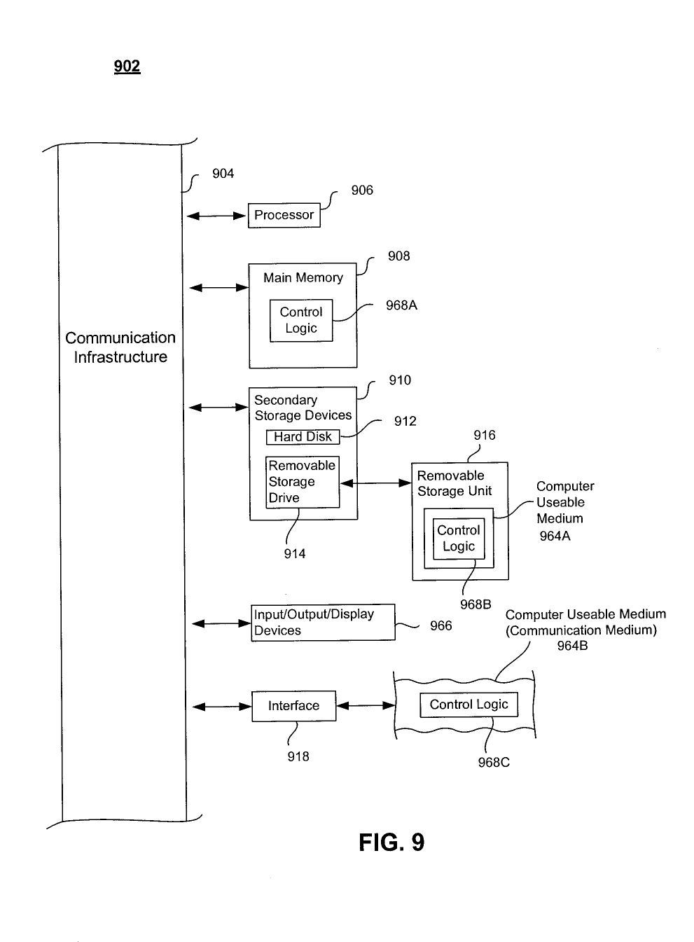

In an embodiment, the system and components of embodiments described herein are implemented using well known computing devices, such as example computer 902 shown in FIG. 9. For example, block LOD creator 108, preprocessing system 130 and client 190 can be implemented using computer(s) 902.

Computer 902 can be any commercially available and well known computer capable of performing the functions described herein, such as computers available from International Business Machines, Apple, Sun, HP, Dell, Compaq, Cray, etc.

Computer 902 includes one or more processors (also called central processing units, or CPUs), such as a processor 906. Processor 906 is connected to a communication infrastructure 904.

Computer 902 also includes a main or primary memory 908, such as random access memory (RAM). Primary memory 908 has stored therein control logic 968A (computer software), and data.

Computer 902 also includes one or more secondary storage devices 910. Secondary storage devices 910 include, for example, a hard disk drive 912 and/or a removable storage device or drive 914, as well as other types of storage devices, such as memory cards and memory sticks. Removable storage drive 914 represents a floppy disk drive, a magnetic tape drive, a compact disk drive, an optical storage device, tape backup, etc.

Removable storage drive 914 interacts with a removable storage unit 916. Removable storage unit 916 includes a computer useable or readable storage medium 964A having stored therein computer software 968B (control logic) and/or data. Removable storage unit 916 represents a floppy disk, magnetic tape, compact disk, DVD, optical storage disk, or any other computer data storage device. Removable storage drive 914 reads from and/or writes to removable storage unit 916 in a well known manner.

Computer 902 also includes input/output/display devices 966, such as monitors, keyboards, pointing devices, Bluetooth devices, etc.

Computer 902 further includes a communication or network interface 918. Network interface 918 enables computer 902 to communicate with remote devices. For example, network interface 918 allows computer 902 to communicate over communication networks or mediums 964B (representing a form of a computer useable or readable medium), such as LANs, WANs, the Internet, etc. Network interface 918 may interface with remote sites or networks via wired or wireless connections.

Control logic 968C may be transmitted to and from computer 902 via communication medium 964B.

Any tangible apparatus or article of manufacture comprising a computer useable or readable medium having control logic (software) stored therein is referred to herein as a computer program product or program storage device. This includes, but is not limited to, computer 902, main memory 908, secondary storage devices 910 and removable storage unit 916. Such computer program products, having control logic stored therein that, when executed by one or more data processing devices, cause such data processing devices to operate as described herein, represent the embodiments.

Embodiments can work with software, hardware, and/or operating system implementations other than those described herein. Any software, hardware, and operating system implementations suitable for performing the functions described herein can be used. Embodiments are applicable to both a client and to a server or a combination of both.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer implemented method for block based level of detail representation of three dimensional (3D) data comprising:
receiving 3D data representative of a scene;
extracting a plurality of 3D models from the 3D data, wherein each 3D model is representative of a building within the scene;
grouping the extracted 3D models into a plurality of groups of 3D models, wherein each group of the plurality of groups of 3D models is based on a building height attribute of the 3D models, wherein the extracted 3D models representative of objects having at least the minimum building height are grouped to one or more of the plurality of groups including a first group, and the extracted 3D models representative of objects having less than the minimum building height are grouped to the remaining one or more of the plurality of groups including a second group;
distributing the first group to a first resolution level of a plurality of resolution levels of a geospatial data structure and distributing the second group to a second resolution level, of the plurality of resolution levels of the geospatial data structure, wherein the first resolution level is different than the second resolution level; and
merging the grouped 3D models, based on the geospatial data structure, to define a plurality of combined 3D models,
wherein the extracting, grouping, distributing and merging steps are performed using one or more processors.

2. The method of claim 1, further comprising:
assigning a list of respective 3D model identifiers to each combined 3D model.

3. The method of claim 1, further comprising:
assigning each combined 3D model to a resolution level of a quadtree data structure.

4. (canceled)

5. The method of claim 1, wherein the grouping step comprises:
grouping the 3D models into a single coordinate frame.

6. The method of claim 5, wherein the grouping step is based on at least a geographical location of the 3D models and terrain associated with the 3D models.

7. The method of claim 1, further comprising:
rendering each combined 3D model into a depth buffer to obtain a height field image representation of the combined 3D model.

8. The method of claim 1, further comprising:
using a morphological opening operation on a height field image representation of each combined 3D model to merge similar shapes in the combined 3D model to reduce level of detail of the combined 3D model to reduce level of detail of the combined 3D model.

9. The method of claim 8, further comprising:
constructing a quadrangular mesh based on the height field image representation of the combined 3D model.

10. The method of claim 9, further comprising:
triangulating the constructed quadrangular mesh to generate an untextured triangulated mesh representing the shape of each combined 3D model.

11. The method of claim 10, further comprising:
splitting the untextured triangulated mesh into a set of non-overlapping triangles to generate a simplified triangulated mesh.

12. The method of claim 11, further comprising:
computing one or more proxy planes using the simplified triangulated mesh.

13. The method of claim 12, further comprising:
associating the non-overlapping triangles with the computed proxy planes.

14. The method of claim 11, further comprising:
generating a textured mesh based on coordinates of mesh vertices in the simplified triangulated mesh.

15. The method of claim 12, further comprising:
generating a textured mesh based on the simplified triangular mesh, the proxy plane, and a combination of the one or more 3D models.

16. The method of claim 13, further comprising:
generating texture images by rendering combined 3D models onto the computed proxy planes associated with the non-overlapping triangles.

17. The method of claim 14, further comprising:
generating texture coordinates for mesh vertices of the simplified triangular mesh based on vertex projections onto the computed proxy planes.

18. A computer based system for block based level of detail representation of three dimensional (3D) data, comprising:
one or more processors configured to receive 3D data representative of a scene;
a preprocessing system configured to extract a plurality of 3D models from the 3D data, wherein each 3D model is representative of an object within the scene;
a block level of detail (LOD) creator configured to group the extracted 3D models into a plurality of groups of 3D models based on a height attribute of the 3D models to generate a first group with 3D models of objects within a first range of heights, a second group with 3D models of objects within a second range of heights, and a third group with 3D models of objects within a third range of heights, wherein the first range of heights, the second range of heights, and the third range of heights do not overlap; and
the block level of detail (LOD) creator is further configured to render the first group of the grouped 3D models as a first combined 3D model having a first level of detail (LOD), the second group of the grouped 3D models as a second combined 3D model having a second level of detail (LOD), and the third group of the grouped 3D models as a third combined 3D model having a third level of detail (LOD), wherein the first level of detail (LOD), second level of detail (LOD), and third level of detail (LOD) are different, and wherein the preprocessing system and the block LOD creator are implemented on the one or more processors.

19. The system of claim 18, wherein the block LOD creator further comprises:
a sorting engine configured to sort the 3D models based on their height at a resolution level and to recursively assign one or more sorted 3D models to a different resolution level of a quadtree data structure.

20. The system of claim 18, wherein the block LOD creator further comprises:
a mesh generator configured to construct a mesh based on a height of each 3D model in the combined 3D model; and
a proxy plane generator configured to compute a proxy plane using a triangulated mesh.
